(19) United States
(12) Patent Application Publication
(10) Pub. No.: US 2006/0181050 A1
(43) Pub. Date: Aug. 17, 2006

(54) Occupant Propelled Transportation Vehicle

(76) Inventor: Jose A. Moreno, Anaheim, CA (US)

Correspondence Address: L.A PATENTS, 21550 OXNARD STREET, SUITE 300, WOODLAND HILLS, CA, 91367, US

(21) Appl. No.: 10/906,322

(22) Filed: Feb. 14, 2005

(51) Int. Cl. B62M 1/00

(52) U.S. Cl. 280/221; 280/252

(57) ABSTRACT

The present invention provides a rectilinear vertical pedal system for an occupant propelled vehicle that has objects of improved ease of use, improved power transmission, and improved stability of the vehicle. Attached at a lower end to a base of the vehicle frame is a substantially vertical linear shuttle guide that contains a linear channel with a moveable shuttle attached to a foot pedal. The vehicle occupant moves the shuttle down through the linear channel by exerting downward force on the pedal. This causes rotational energy to be transferred through a transmission mechanism to a propeller, such as a wheel, attached to the vehicle frame, thus moving the vehicle. A spring mechanism is used to return the shuttle back towards the top of the linear channel so that the user may again, as desired, move the pedal downwards and impart more rotational energy to the propeller, and move the vehicle forward.

### BACKGROUND OF THE INVENTION

The present invention relates to an improved occupant propelled vehicle, and in particular to an improved occupant propelled two wheeled vehicle, such as a scooter.

### BRIEF SUMMARY OF THE INVENTION

The present invention provides a rectilinear vertical pedal system for an occupant propelled vehicle that has objects and utility of improved ease of use, improved power transmission, and improved stability of the vehicle.

### BRIEF DESCRIPTION OF THE DRAWINGS

FIG. 1: Left view of two wheel scooter incorporating vertical pedal drive system.

FIG. 2: Left view of vertical one pedal drive system on scooter.

FIG. 3: Left perspective view of one piece shuttle guide.

FIG. 4: Left perspective view of two piece shuttle guide.

FIG. 5: Top view of two piece shuttle guide.

FIG. 6: Exploded view of moveable shuttle, pedal, and pedal mounting bracket.

FIG. 7: Exploded sectional view of vertical pedal drive system.

FIG. 8: Exploded view of transmission assembly.

FIG. 9: Right sectional view of transmission assembly and shuttle guide.

FIG. 10: Left view of vertical two pedal drive system scooter.

FIG. 11: Top view of vertical two pedal drive system scooter.

FIG. 12: Exploded view of shuttle guides, transmission assemblies, axle assemblies and sprocket assemblies for vertical two pedal drive system.

FIG. 13: Exploded view of vertical two pedal drive system.

### DETAILED DESCRIPTION OF THE INVENTION

Referring to FIG. 1, in a preferred embodiment of the invention an occupant propelled vehicle for transportation is a two wheeled vehicle, such as scooter 10. While the preferred embodiment shown is a two-wheel scooter, the present invention is not so limited, and may be applied to any occupant propelled vehicle. Scooter 10 is provided with a vertical one pedal linear drive mechanism 20. Vertical one pedal linear drive mechanism 20 may be provided during the manufacture of an occupant propelled vehicle such as a scooter, or manufactured separately as an add-on component for an already manufactured vehicle.

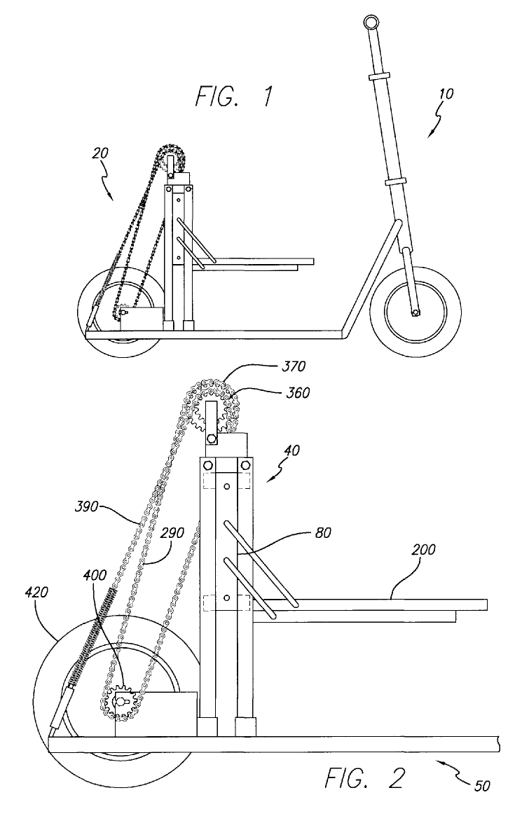

Referring to FIG. 2, a linear shuttle guide 40 is attached to the base of frame 50 of scooter 10. In a preferred embodiment shuttle guide 40 is perpendicular to the base of frame 50 so that linear shuttle guide 40 extends upwards from the base of frame 50 vertically. While the illustration of the preferred embodiment shows linear shuttle guide 40 being perpendicular to the base of frame 50, it is to be understood that linear shuttle guide 40 may form any angle with the base of frame 50, so long as it is substantially vertical.

In the preferred embodiment shown, linear shuttle guide 40 is located proximate to propelling means (“propeller”) 420 of scooter 10. In the illustrated preferred embodiment the propeller shown is a tire on a wheel, such as for example 12″ pneumatic wheels, or solid polyurethane wheels. However the propeller may be any type of propelling means that imparts motion to the frame through forces of friction, or otherwise, including for example the paddle wheel of a paddle boat. The frame of linear shuttle guide 40 in a preferred embodiment for a two-wheeled scooter is made of extruded aluminum alloy. For the situation where vehicle 10 is manufactured with vertical pedal linear drive mechanism 20, preferably frame 50 is also made of aluminum alloy so that shuttle guide 40 may be welded to frame 50.

Referring to FIG. 3, linear shuttle guide 40 in a first preferred embodiment has a substantially cubical shape. Linear shuttle guide 40 contains linear channel 70 preferably running along a substantial portion, or all, of its length. There is opening 45 in two facing side walls of linear shuttle guide 40 to facilitate attachment of pedal 200 to moveable shuttle 80 as described below. Linear shuttle guide 40 may be welded, fastened, and/or bracketed, to the base of frame 50 as appropriate. Additional mechanical support may be provided as needed to ensure the strength and stability linear shuttled guide 40.

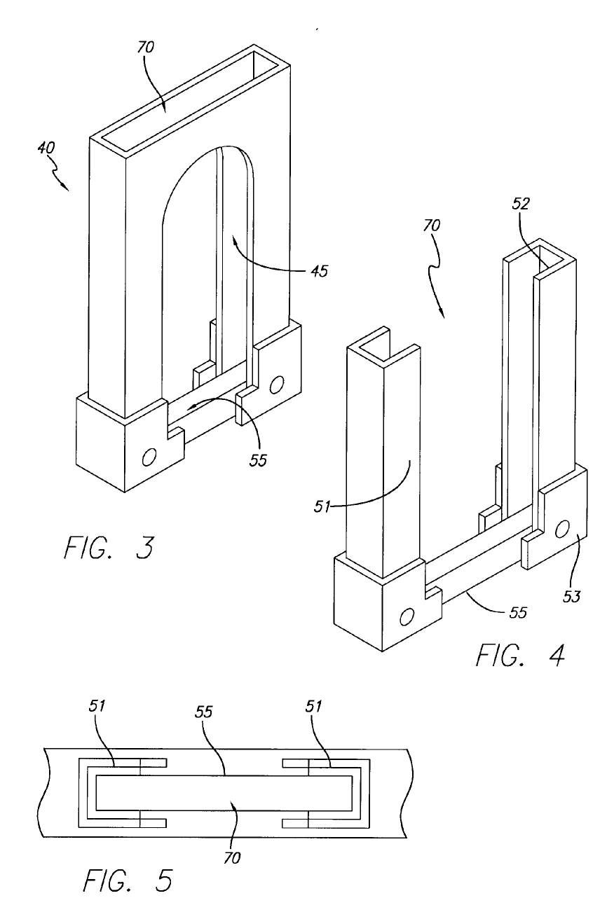

Referring to FIG. 4, in a second preferred embodiment, linear shuttle guide 40 may be constructed from two distinct oppositely facing u-shaped guides 51. Each guide 51 has a longitudinal recess 52 preferably running a substantial portion, or all, of its length. U-shaped guides 51 are attached to frame 50 of scooter 10 at their lower ends with frame brackets 53 that may be welded to frame 50. At the location of frame brackets 53, extending between u-shaped guides 51 and occupying the bottom portion of each longitudinal recess 52, is bottom stop 55. U-shaped guides 51 may be fastened to frame brackets 53 using fasteners that extend through and join securely together frame bracket 53, u-shaped guide 51, and bottom stop 55. In this embodiment, linear channel 70 is defined by the space between the walls of u-shaped guides 51 as shown for example in FIG. 5. Additional mechanical support may be provided as needed to ensure the strength and stability of each u-shaped guide 51.

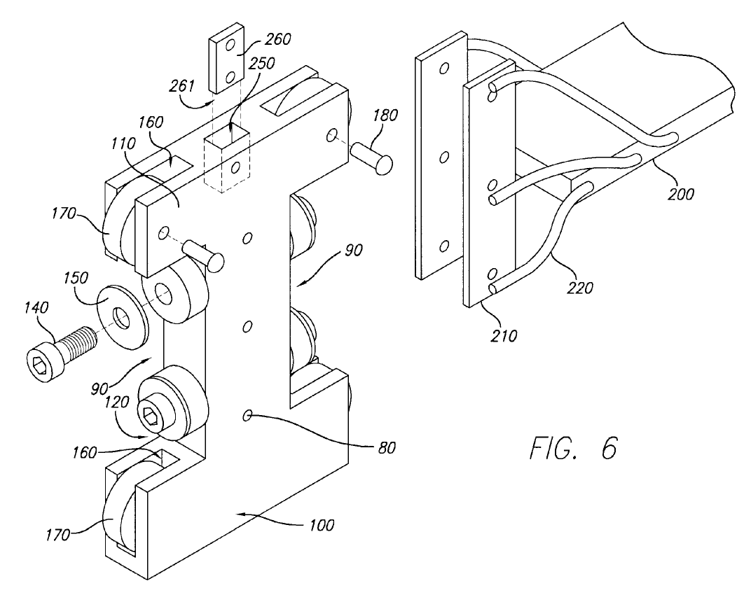

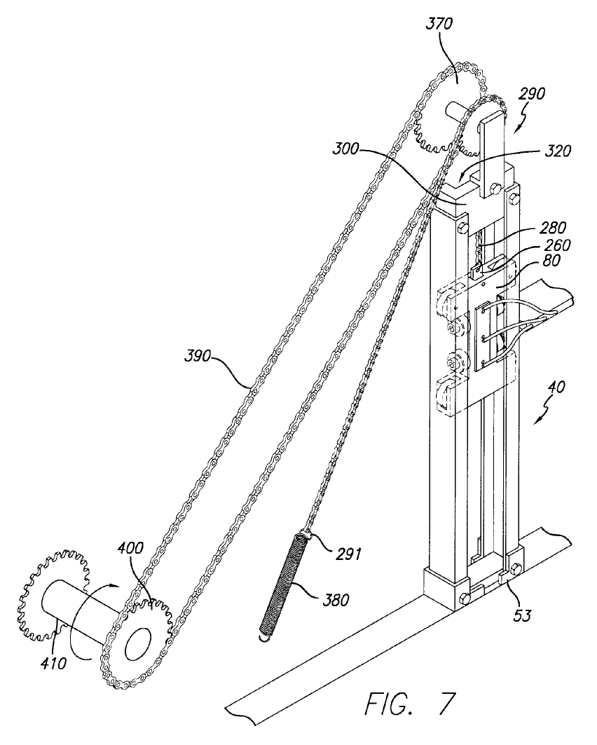

Referring to FIG. 7, linear channel 70, of either first or second preferred embodiment of linear shuttle guide 40, is of a shape and size to accommodate within it moveable shuttle 80. Referring to FIG. 6, in a preferred embodiment shuttle 80 is constructed from a single substantially cubical piece of metal, such as for example stainless steel or aluminum alloy. In a preferred embodiment, moveable shuttle 80 has two opposite facing lateral recesses 90 between a lower end 100 and an upper end 110.

Located in each lateral recess may be lateral bearings 120. Lateral bearings 120 are attached to lateral recess walls 130 using fasteners 140 which may be, for example, a shoulder screw. Preferably spacers 150 are used when attaching lateral bearings 120 to recess walls 130 with fasteners 140. Lateral bearings 120 should rotate freely about fasteners 140.

Lower end 100 of shuttle 80 may contain bearing recesses 160 that accommodate end bearings 170. End bearings 170 are rotatably mounted within bearing recesses 160 using fasteners 180, which may be for example, rivets. Similarly, upper end 110 also contains bearing recesses 160 that accommodate end bearings 170 rotatably mounted on fasteners 180.

In a preferred embodiment, end bearings 170 are mounted on a rotational axis, defined by fasteners 180, that is perpendicular to the rotational axis of lateral bearings 120, defined by fasteners 140. In this way, when moveable shuttle 80 is located within linear channel 70, end bearings 170 and lateral bearings 140 make contact with all interior surface walls of shuttle guide 40. In this way shuttle 80 cannot move laterally within linear shuttle guide 40, but is free to move in a linear fashion up and down the length of linear channel 70, with end bearings 170 and lateral bearings 120 rotating about their fasteners and thus minimizing frictional forces between moveable shuttle 80 and the walls of linear shuttle guide 40.

In the illustrated preferred embodiment pedal 200 is attached to mounting bracket 210 by extenders 220. In a preferred embodiment there is a pedal base to which extenders 220 are attached. Said extenders 220 and said pedal base may both be metal, and are attached by welding or a similar process. The other ends of extenders 220 are welded, or otherwise fixedly attached, to mounting bracket 210. Mounting bracket 210 and pedal 200 are preferably attached by extenders 220 at an orthogonal angle to one another.

In a first preferred embodiment, mounting bracket 210 is fixedly attached to shuttle 80 through opening 45. In a second preferred embodiment, mounting bracket 210 is fixedly attached to shuttle 80 through the opening between u-shaped guides 51. Fixed attachment of mounting bracket 210 to shuttle 80 may be achieved, for example, by the use of fasteners, such as bolts or rivets. In the illustrated preferred embodiment shown pedal 200 is in-line with (e.g. in front of) linear shuttle guide 40. However, pedal 200 may also be attached to moveable shuttle 80 to the side of linear shuttle guide 40, or otherwise be offset from being in-line with linear shuttle guide 40.

Referring to FIG. 6 and FIG. 7, upper end 110 of moveable shuttle 80 contains top recess 250 for receiving chain link block 260 with a first end 261 and second end 262. First end 261 extends into top recess 250. A fastener, such as a bolt, extends through upper end 110 and first end 261 so as to attach chain link block 260 to moveable shuttle 80. A first end 280 of linear chain 290 is attached to chain link block 260 at second end 262 that extends out of top recess 250.

At upper end 41 of linear shuttle guide 40 is transmission assembly 300 that is partly disposed within linear channel 70. In a preferred embodiment the base of transmission assembly 300 is made of metal and is attached to linear shuttle guide 40 with fasteners 310, which may be screws or bolts. The base of transmission assembly 300 is used to stop the upward movement of moveable shuttle 80 when it is traveling through linear channel 70. Transmission assembly 300 contains channel 320 through which passes linear chain 290.

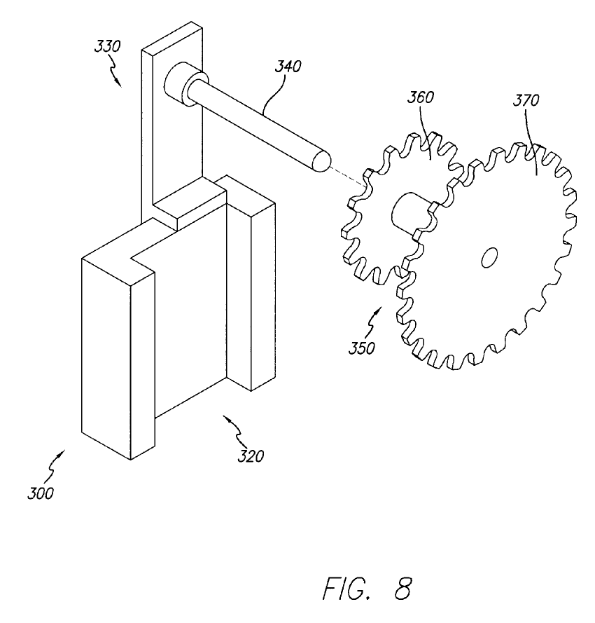

Referring to FIG. 8, in a preferred embodiment, transmission assembly 300 has axle assembly 330. Axle assembly 330 may be attached to transmission assembly 300 by means of a fastener, by welding, soldering, or any other appropriate means. Axle assembly 330 has an axle 340 that is preferably one piece with axle assemble 330.

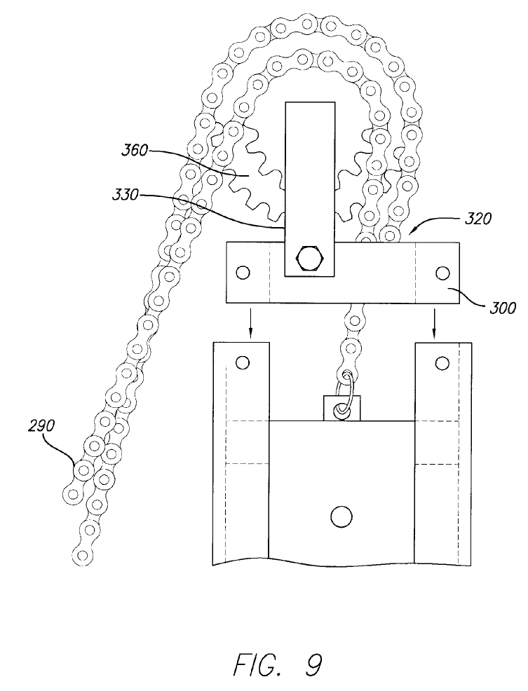

Referring to FIG. 9, in a preferred embodiment, sprocket assembly 350 is placed in a freely rotatable manner on axle 340. Sprocket assembly 350 may comprise adjacently placed small sprocket 360 and large sprocket 370 that are joined together fixedly such that they will rotate together in a unitary fashion about axle 340. Alternatively, sprockets 360 and 370 may be joined together in a ratcheted manner such that only the forward rotation of small sprocket 360 causes forward rotation of large sprocket 370 about axle 340. Sprocket assembly 350 is positioned on axle 340 such that small sprocket 360 extends approximately half way over channel 320.

From where it is attached to chain link block 260, linear chain 290 extends up through channel 320 to be engaged at a midsection (any location between the ends of linear chain 290) over the teeth of small sprocket 360, with the other end linear chain 290 being attached to a first end of spring 380. A second end of spring 380 is attached to frame 50.

Referring to FIG. 7, elliptical chain 390 is engaged at one end over the teeth of large sprocket 370, and at the other end over the teeth of propeller sprocket 400. Propeller sprocket 400 is preferably attached in a ratcheted manner to freewheel 410. In this way only the forward rotation of propeller sprocket 400 moves rear wheel 420, which can continue to rotate forward even when propeller sprocket is not rotating in a forward direction. Because of the ratcheted attachment of propeller sprocket 400, any rearward rotation of propeller sprocket 400 will not impart any rotational energy to propeller 420.

In a preferred embodiment, linear shuttle guide 40 may be in-line with propeller 420 to provide increased stability during use of vehicle 10. Linear shuttle guide 40 is “in-line” with propeller 420 when it is substantially in front of propeller 420 on the centerline of vehicle 10.

In a preferred embodiment, the operator of vehicle 10 exerts a downward force on pedal 200 using his right or left foot. This causes moveable shuttle 80 to move downwards in a linear fashion through linear channel 70. The linear downward movement of moveable shuttle 80 causes linear chain 290 to rotate forward small sprocket 260. The forward rotation of small sprocket 260 in turn causes adjacent large sprocket 270 to rotate forward. The forward rotation of large sprocket 270 causes the forward rotation of elliptical chain 390 which in turn causes the forward rotation of propeller sprocket 400. The forward rotation of propeller sprocket 400 imparts forward rotational energy to freewheel axle 410, which in turn rotates propeller 420, which causes vehicle 10 to move forward.

Once moveable shuttle 80 makes contact with bottom stop 55 the operator can then release the downward force being exerted on pedal 200. At this point the movement of linear chain 290 has extended spring 380, which then recoils and pulls moveable shuttle 80 back up through linear channel 70 until it makes contact with transmission assembly 300. The recoil of spring 380 causes linear chain 290 to rotate in a rearward fashion small sprocket 360. This may, depending upon whether they are attached in a ratcheted fashion or not, cause large sprocket 370 to rotate backwards, which in turn will impart a rearward rotation to propeller sprocket 400 through elliptical chain 390. However, as stated above, because in a preferred embodiment propeller sprocket 400 is attached in a ratcheted fashion to freewheel axle 410 the rearward rotation of propeller sprocket 400 is not imparted to propeller 420.

The operator may once shuttle 80 has returned to its uppermost position at transmission assembly 300 again exert a downward force on pedal 200 to impart more rotational energy to propeller 420 as described above. However, it is not necessary for moveable shuttle 80 to return to transmission assembly 300 before again exerting downward force on pedal 200, and the operator may do so while moveable shuttle 80 is somewhere between transmission assembly 300 and bottom stop 55.

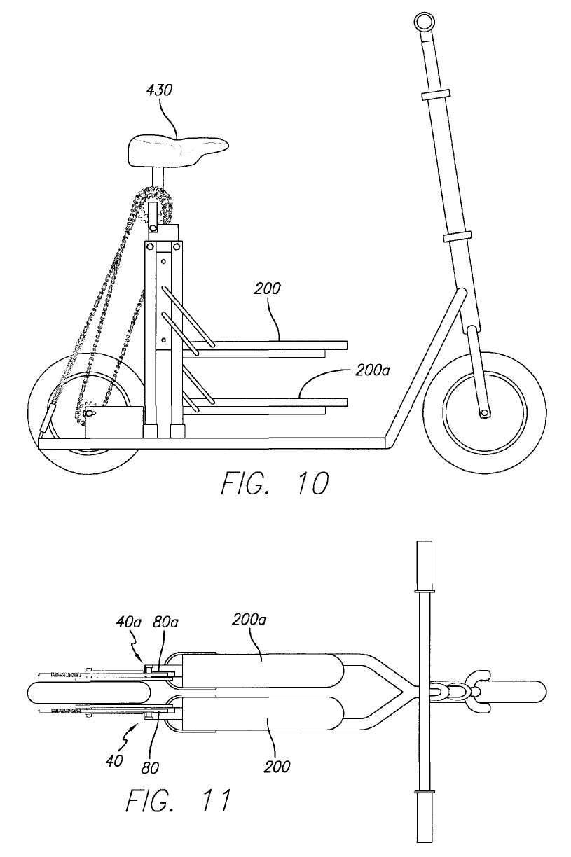

The above preferred embodiments of the herein claimed invention have been directed at a vehicle 10 with one moveable shuttle 80, one linear shuttle guide 40, and one pedal 200. However, in an alternative preferred embodiment, shown in FIGS. 10-13, there may be two moveable shuttles 80 and 80a, two linear shuttle guides 40 and 40a, and two pedals 200 and 200a, adjacent to one another. Moveable shuttle 80, linear shuttle guide 40, and peddle 200 may be disposed slightly to the right of the centerline for vehicle 10, while moveable shuttle 80a, linear shuttle guide 40a, and peddle 200a may be disposed slightly to the left of the centerline.

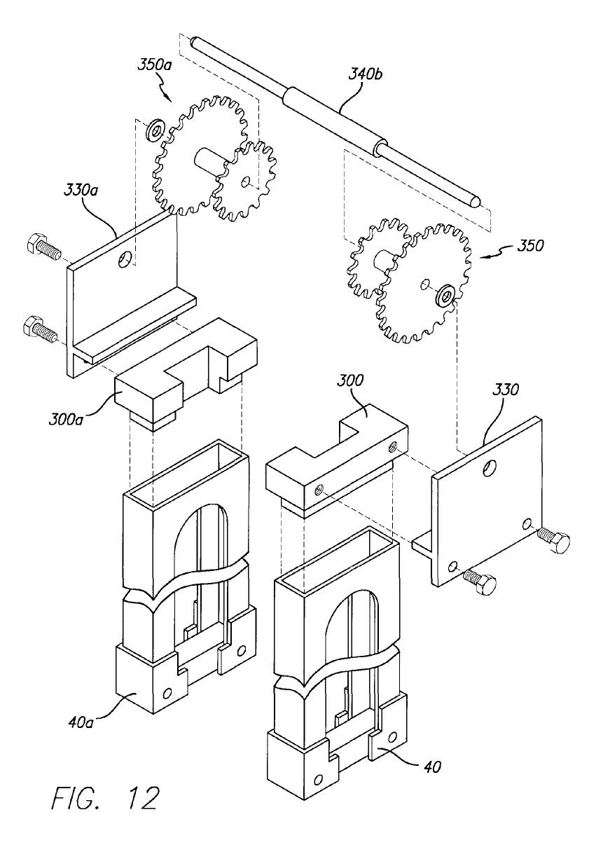

Referring to FIG. 12, each linear shuttle guide 40 and 40a would have attached to them transmission assemblies 300 and 300a, which in turn would have axle assemblies 330 and 330a. Axle assemblies 330 and 330a may share between them a single common axle 340b that is attached at each end to axle assemblies 330 and 330a, or alternatively each axle assembly would have its own attached axle as described above. On each axle 340 and 340a, or the common axle 340b if that is the case, would be rotatably mounted sprocket assemblies 350 and 350a.

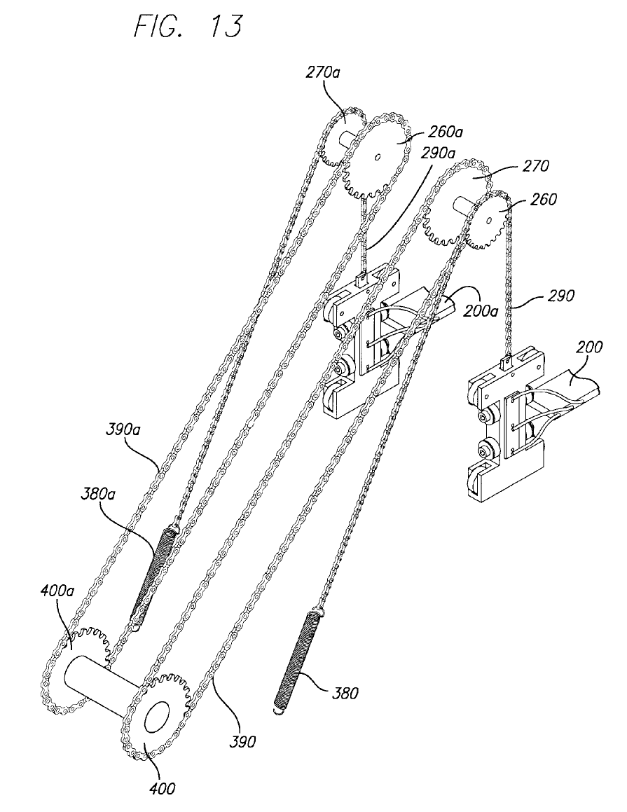

Referring to FIG. 13, linear chains 290 and 290a would engage at their midsections with the teeth of small sprocket 360 and 360a respectively, with second ends 291 and 291a being fixedly attached to springs 380 and 380a at ends 381 and 381a respectively. Spring ends 382 and 382a are attached to frame 50. Elliptical chains 390 and 390a are engaged over the teeth of large sprockets 370 and 370a respectively at ends 391 and 391a. At ends 392 and 392a elliptical chains 390 and 390a are engaged over the teeth of propeller sprockets 400 and 400a. Propeller sprockets 400 and 400a are preferably attached in a ratcheted manner to at least one freewheel axle 410. In this way only the forward rotation of propeller sprockets 400 and 400a moves propeller 420, that may continue to rotate forward, even when propeller sprockets 400 and 400a are not rotating in a forward direction. Because of the ratcheted attachment of propeller sprockets 400 and 400a, any rearward rotation of propeller sprockets 400 or 400a will not impart any rotational energy to propeller 420. Propeller sprockets 400 and 400a should rotate independently of one another so that pedals 200 and 200a operate independently. This may be achieved, for example, by the use of two independent one way bearings.

In the above described embodiment where there are two moveable shuttles 80 and 80a, two linear shuttle guides 40 and 40a, and two pedals 200 and 200a, the operator of vehicle 10 exerts a downward force on each pedal 200 and 200a using his left or right foot respectively. As described above, this causes each moveable shuttle 80 and 80a to move downwards in a linear fashion through linear channel 70 and 70a respectively. The linear downward movement of moveable shuttles 80 and 80a causes linear chains 290 and 290a to rotate forward small sprockets 260 and 260a. The forward rotation of small sprockets 260 and 260a in turn causes adjacent large sprockets 270 and 270a to rotate forward. The forward rotation of large sprockets 270 and 270a causes the forward rotation of elliptical chains 390 and 390a which in turn causes the forward rotation of propeller sprockets 400 and 400a respectively. The forward rotation of propeller sprockets 400 and 400a imparts forward rotational energy to propeller 420, which causes vehicle 10 to move forward.

Once moveable shuttle 80 or 80a has returned to the uppermost position at transmission assembly 300 or 300a under the recoil force of spring 380 or 380a, as the case may be, the operator may again exert a downward force on pedal 200 and/or 200a to impart more rotational energy to propeller 420 as described above. It is not necessary for moveable shuttle 80 or 80a to return to transmission assembly 300 or 300a before again exerting downward force on pedal 200 or 200a. The operator may do so while shuttle 80 or 80a is somewhere between transmission assembly 300 or 300a and bottom stop 55 or 55a.

Similarly, while the operator may choose to alternate between pedal 200 and 200a when exerting a downward force, this is not necessary. The operator may exert downward force on both pedals at the same time, or use just one pedal.

In a preferred embodiment of the described invention a seat 430 may be provided to increase operator comfort. As may be a safety guard around assembly 350. It will also be understood to those of ordinary skill in the art that the present invention may be adapted for use on any number of occupant propelled vehicle configurations, that may include such standard features as braking and steering mechanisms, lights, different shaped frames, and different types of propelling means (e.g. wheels, boat propellers, etc.). The preferred embodiments disclosed in the present specification are intended only as examples of the invention, and are not exhaustive of the many different implementations of the invention readily ascertainable to those of ordinary skill in the art.

What is claimed is:

1. An occupant propelled transportation vehicle comprising:
a frame;
said frame having a base to support an occupant;
a propeller attached to said frame;
a linear shuttle guide attached at a lower end to said base;
said linear shuttle guide extending substantially vertically above said base;
said linear shuttle guide having a linear channel;
a pedal attached to a moveable shuttle located within said linear channel;
said moveable shuttle attached to said propeller by a transmission mechanism operative to impart rotational energy to said propeller.

2. The occupant propelled transportation vehicle of claim 1 wherein the transmission mechanism comprises:
a transmission assembly attached to an upper end of said linear shuttle guide;
said transmission assembly having a first sprocket and a second sprocket;
a linear chain being attached at a first end to said moveable shuttle, attached at a second end to a spring, and engaged with said first sprocket at a chain midsection; and
an elliptical chain engaged with said second sprocket and a propeller sprocket;
said propeller sprocket being attached to a propeller axle that is attached to said propeller.

3. The occupant propelled vehicle of claim 1 wherein said linear shuttle guide is in-line with said propeller.

4. The occupant propelled vehicle of claim 2 wherein said linear shuttle guide is in-line with said propeller.

5. The occupant propelled vehicle of claim 1 wherein said pedal is in-line with said linear shuttle guide.

6. The occupant propelled vehicle of claim 2 wherein said pedal is in-line with said linear shuttle guide.

7. The occupant propelled vehicle of claim 1 further comprising said moveable shuttle having a bearing to reduce friction between said moveable shuttle and said linear shuttle guide.

8. The occupant propelled vehicle of claim 2 further comprising said moveable shuttle having a bearing to reduce friction between said moveable shuttle and said linear shuttle guide.

9. A method of making an occupant propelled transportation vehicle comprising the steps of:
providing a frame with a base to support an occupant;
attaching a propeller to said frame;
providing a linear shuttle guide having a linear channel;
attaching a lower end of said linear shuttle guide to said base;
placing a moveable shuttle into said linear channel;
attaching a pedal to said moveable shuttle; and
attaching said moveable shuttle to said propeller with a transmission mechanism operative to impart rotational energy to said propeller.

10. The method of making an occupant propelled transportation vehicle of claim 9 wherein the transmission mechanism provided comprises:
a transmission assembly attached to an upper end of said linear shuttle guide;
said transmission assembly having a first sprocket and a second sprocket;
a linear chain being attached at a first end to said moveable shuttle, attached at a second end to a spring, and engaged with said first sprocket at a chain midsection; and
an elliptical chain engaged with said second sprocket and a propeller sprocket;
said propeller sprocket being attached to a propeller axle that is attached to said propeller.

11. The method of making an occupant propelled transportation vehicle of claim 9 further comprising the step of placing said linear shuttle guide in-line with said propeller.

12. The method of making an occupant propelled transportation vehicle of claim 10 further comprising the step of placing said linear shuttle guide in-line with said propeller.

13. The method of making an occupant propelled transportation vehicle of claim 9 further comprising the step of placing said pedal in-line with said linear shuttle guide.

14. The method of making an occupant propelled transportation vehicle of claim 10 further comprising the step of placing said pedal in-line with said linear shuttle guide.

15. The method of making an occupant propelled transportation vehicle of claim 9 further comprising the step of providing said moveable shuttle with a bearing to reduce friction between said moveable shuttle and said linear shuttle guide.

16. The method of making an occupant propelled transportation vehicle of claim 10 further comprising the step of providing said moveable shuttle with a bearing to reduce friction between said moveable shuttle and said linear shuttle guide.
